(19) United States
(12) Patent Application Publication
(10) Pub. No.: US 2025/0045782 A1
(43) Pub. Date: Feb. 6, 2025

(54) RETAIL SALES FORECAST WITH CLUSTERING

(71) Applicant: Walmart Apollo, LLC, Bentonville, AR (US)

(72) Inventors: Yuting Han, Bentonville, AR (US); Wenyue Shi, Bentonville, AR (US); Michael Smith, Denton, TX (US)

(21) Appl. No.: 18/789,188

(22) Filed: Jul. 30, 2024

Related U.S. Application Data
(60) Provisional application No. 63/530,666, filed on Aug. 3, 2023.

(51) Int. Cl. G06Q 30/0202; G06Q 10/1093

(52) U.S. Cl. CPC G06Q 30/0202; G06Q 10/1093

(57) ABSTRACT

A system for retail forecasting and task management. The system includes a sales history database storing sales histories associated with a plurality of store locations; a network adapter; and a control circuit. The control circuit is configured to: provide, via the network adapter, a retail task user interface on a user device at a store location; cluster a plurality of store locations based on shared characteristics; determine a local sales forecast value on a future date for the store location based on a sales history of the store location using a first forecast model; determine a group sales forecast value on the future date based on sales histories of other store locations using the first forecast model; determine an adjusted sales forecast for the store location based on the local sales forecast value and the group sales forecast value; and provide the adjusted sales forecast.

### TECHNICAL FIELD

This present disclosure relates generally to computer model-based retail sales forecasting and particularly to sales forecasting with clustering.

### BACKGROUND

Conventionally, preparations for retail store sale surges are managed as institutional knowledge. Thus, in preparing for anticipated upcoming sale surges related to planned store- or event-specific events, the level of preparation is largely dependent on the retail store's manager's level of expertise. Additionally, sales forecasting and management can often be unpredictable in accounting for various unplanned events, such as weather events, that are unknown to the retailer store's manager.

### SUMMARY

The disclosed examples are described in detail below with reference to the accompanying drawing figures listed below. The following summary is provided to illustrate some examples disclosed herein.

Example solutions include various systems and methods for retail forecasting and task management. One such system includes a sales history database storing sales histories associated with a plurality of store locations; a network adapter; and a control circuit. The control circuit is configured to: provide, via the network adapter, a retail task user interface on a user device at a store location; cluster a plurality of store locations based on shared characteristics; determine a local sales forecast value on a future date for the store location based on a sales history of the store location using a first forecast model; determine a group sales forecast value on the future date based on sales histories of other store locations using the first forecast model; determine an adjusted sales forecast for the store location based on the local sales forecast value and the group sales forecast value; and provide the adjusted sales forecast.

### BRIEF DESCRIPTION OF THE DRAWINGS

Disclosed herein are embodiments of apparatuses and methods for providing sales forecasting. This description includes drawings, wherein:

FIG. 1 comprises a block diagram of a system in accordance with some embodiments;

FIG. 2 comprises a flow diagram in accordance with some embodiments;

FIG. 3 comprises an illustration of store clustering in accordance with some embodiments; and

FIGS. 4A, 4B, 4C, 4D, 4E, and 4F are illustrations of a retail task user interface with integrated sales forecasting in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein for providing retail sales forecasts and task management. The system includes: a sales history database storing sales histories associated with a plurality of store locations; a network adapter; and a control circuit coupled to the sales history database and the network adapter, the control circuit being configured to: provide, via the network adapter, a retail task user interface on a user device at a store location; cluster a plurality of store locations based on shared characteristics, the plurality of store locations includes the store location; determine a local sales forecast value on a future date for the store location based on a sales history of the store location using at least a first forecast model; determine a group sales forecast value on the future date based on sales histories of other store locations of the plurality of store locations using at least the first forecast model; determine an adjusted sales forecast for the store location based on the local sales forecast value and the group sales forecast value; and provide, on the retail task user interface, the adjusted sales forecast.

When planning for events, tools and insights can help store managers and team members proactively plan, make informed decisions, and efficiently execute tasks to enhance customer experience. In some embodiments, the sales forecasting and task management tool described herein may be used to plan for events such as national holidays, store-specific events (e.g., sales events), local events (e.g., sports games), and unplanned events (e.g., weather events). Events such as national holidays can lead to sales spikes in individual stores that differ from national trends, which makes it difficult for store managers to prepare for their specific store customers. Conventionally, preparations for sale surges are managed as institutional knowledge and depend heavily on the manager's level of expertise, which could lead to lost sales. Store managers can benefit from knowing changes in customer shopping habits during events so that the store can be stocked and merchandised accordingly to meet that shift in demand.

Store and event-specific forecasting can be different from the centralized demand forecasting for inventory ordering, which is generally supply-side and replenishment focused. Task assignments for in-store and on-shelf inventory need to respond to faster fluctuations (day-to-day, even hour-to-hour) in demand as compared to supply-side demand changes.

In some embodiments, a task management system with integrated event insights allows associates to proactively plan for shifts in demand, rather than waiting until customers are already impacted. In some embodiments, the system identifies actionable insights, identifying shifts in customer demand which might otherwise be overlooked. In some embodiments, the system predicts daily demand for a club at the category, sub-category, and top items for each, providing a whole picture view to users. In some embodiments, the system may also provide forecasts on local traffic, total units vs. stocking units, and more, to allow managers to assign tasks to meet customer needs. In some embodiments, the system also provides an interface that allows associates to easily find relevant information on events in one location.

In some embodiments, the system provides forecasts with expected changes in sales for a store, categories sold in the store, sub-categories sold in the store, and top items in each category/sub-category. In some embodiments, the system may display expected revenue and/or sale lift as change percentage. In some embodiments, the system may further provide information on total units and stocking units for one or more items, possible substitutes for items in demand, peak traffic days, and expected total transactions.

In some embodiments, the system may suggest and/or automatically assign tasks based on the forecast. For example, if there is sufficient selling stock to meet the predicted increase in demand, a task may be to zone and straighten the associated sales area. If there is not sufficient selling stock but there is more inventory in reserve, the task may be to drop pallets. If there is no inventory in reserve but there is incoming inventory in the pipeline, the task may be to expedite stock from trucks to the floor upon arrival. If no additional inventory is in the pipeline, and there are other items that could meet the demand, the task may be to stage the substitute item until more inventory arrives.

In some embodiments, sales insights for a holiday may be determined by combining two or more sales forecasting models to increase accuracy and reduce forecast errors. For example, one model may be an additive time series forecast model wherein non-linear trends are fit with yearly, weekly, and daily seasonality, along with holiday effects (e.g., FBprophet model). In some embodiments, another model may be a weighted average forecast model with anomaly detection. In some embodiments, the system may first predict a baseline demand based on long-term data and then predict a change in demand based on events such as holidays. In some embodiments, the system further identifies/prioritizes actionable categories and subcategories based on the forecast.

In some embodiments, the system uses a three-year rolling window to generate forecasts. In some embodiments, time decay is applied such that recent data are weighted more heavily than older data. In some embodiments, the system includes tunable business thresholds so that only the most important insights are surfaced/prioritized in the user interface. In some embodiments, the system uses a reusable model that can be applied to other events that impact store sales, such as community events or sporting events. In some embodiments, event window identification is based on actual sales patterns and is event specific.

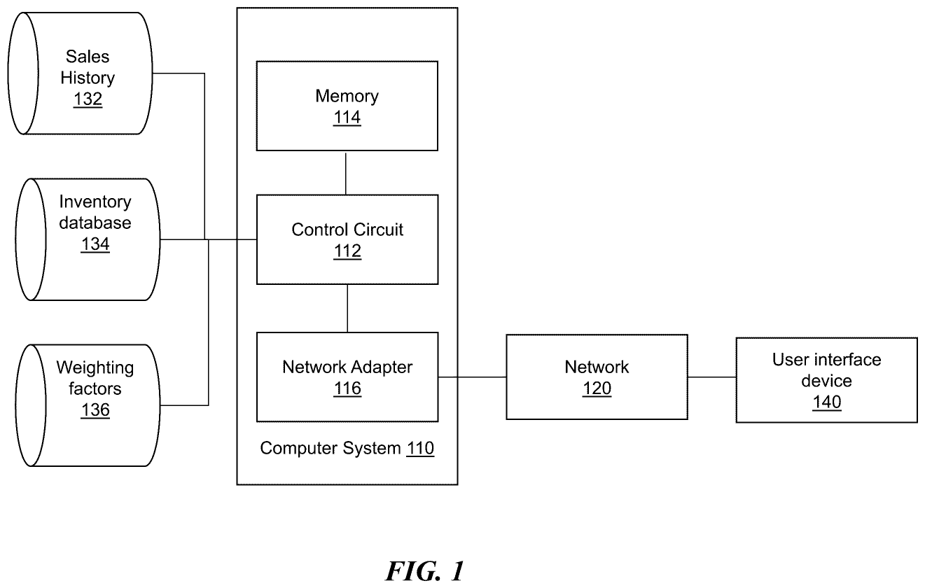

Referring now to FIG. 1, a system for sales forecast for task management is shown. The computer system 110 is coupled to a user interface device 140 via a network 120, a sales history database 132, an inventory database 134, and a weighting factor database 136.

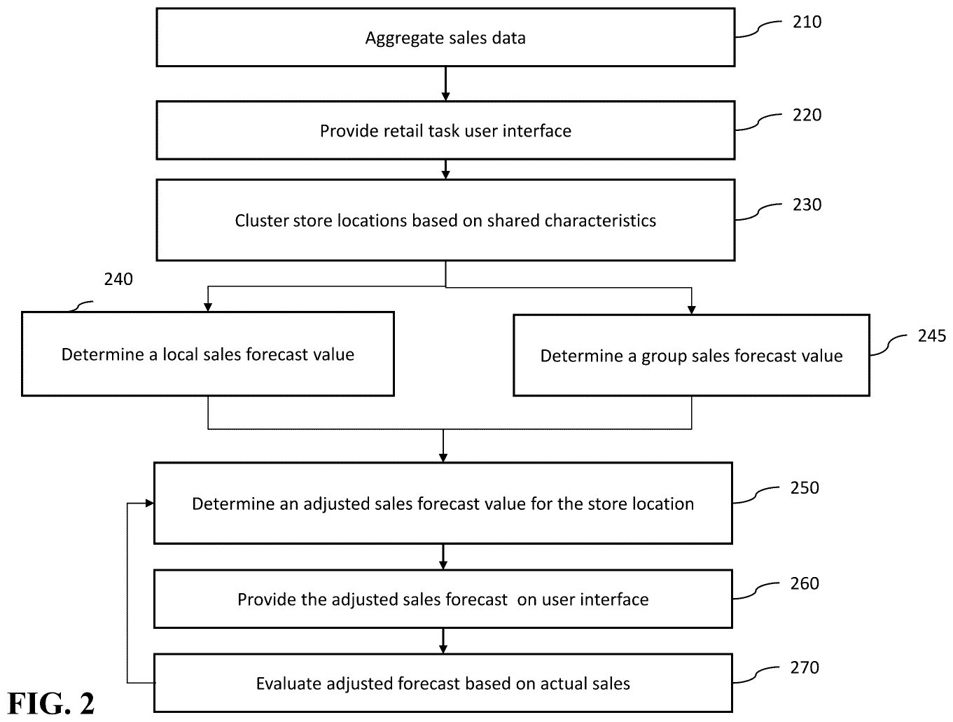

The computer system 110 comprises a control circuit 112, a memory 114, and a network adapter 116. The computer system 110 may comprise one or more of a server, a central computing system, a cloud-based compute engine, a desktop computer system, a personal computer, a portable device, and the like. The control circuit 112 may comprise a processor, a microprocessor, a central processing unit (CPU), a graphics processing unit (GPU), an application-specific integrated circuit (ASIC), and the like and may be configured to execute computer-readable instructions stored on a computer-readable storage memory 114. The computer-readable storage memory 114 may comprise volatile and/or non-volatile memory and have stored upon it, a set of computer-readable instructions which, when executed by the control circuit 112, causes the computer system 110 to provide a retail task user interface and sales forecasting based on the information in sales history database 132, the inventory database 134, and/or the weighting factor database 136. In some embodiments, the computer-executable instructions may cause the control circuit 112 of the computer system 110 to perform one or more steps described with reference to FIG. 2 herein. In some embodiments, the computer-executable instructions may cause the control circuit 112 of the computer system 110 to provide a retail task user interface, for viewing and interacting with event sales forecasts and retail tasks via a user interface device 140.

The network adapter 116 may comprise a data port, a wired or wireless network adapter, and the like. In some embodiments, the computer system 110 may communicate with the user interface device 140 over one or more networks 120 such as a local network, a private network, a cloud computing network, or the Internet. The user interface device 140 comprises user input/output devices such as a keyboard, a mouse, a touch screen, a display screen, a virtual reality/augmented reality display device, a speaker, a microphone, etc. In some embodiments, the user interface device 140 may be a processor-based standalone user device such as a personal computer, a desktop computer, a laptop computer, a mobile device, a smartphone, and the like. The user interface device 140 may execute a retail task application for displaying sales forecast data and/or retail tasks based on data provided by the computer system 110. In some embodiments, the user interface device 140 may further be used to generate, assign, and/or accept tasks in the retail task user interface. In some embodiments, the user interface device 140 may comprise the input/output user interface of the computer system 110.

The sales history database 132 stores sales history from a plurality of store locations. In some embodiments, the store locations include physically separate stores, stores in different cities, counties, states, etc. In some embodiments, sales history may comprise the sale volume of individual items, category of items, and/or subcategory of items per day, week, and/or hour. The sales history stored in the sales history database 132 may be used by forecast models to perform sales forecasts. In some embodiments, the computer system 110 may also compare sales forecasts with actual sales data recorded in the sales history database 132 to update weighting factors in the weighting factor database 136.

The inventory database 134 stores inventory data for one or more store locations. In some embodiments, inventory data may comprise on-shelf inventory data, reserve inventory data, and/or incoming inventory data for a plurality of items offered for sale at one or more store locations. In some embodiments, the inventory data for one or more items may be displayed in the user interface along with event sales forecasts. In some embodiments, inventory data may be used to suggest and/or assign tasks based on the event sales forecast.

The weighting factor database 136 stores weighting factors for determining adjusted sales forecast based on clustering store data. In some embodiments, the weighting factor database 136 may store weighting factors associated with stores, events, and/or items. For example, a weighting factor may be specific to a store location and the event of the Fourth of July. In another example, a weighting factor may be specific to a store location, charcoal, and Fourth of July. In some embodiments, the weighting factors in the weighting factor database 136 may be updated by the control circuit 112 based on comparing forecasts with actual sales.

In some embodiments, the system may access and/or store information on other databases for supporting the functions described herein. For example, a store database may store location characteristics, an items database may store item categorization and characteristics, a user database may store user credentials for logging into the retail task user interface, a task database may store tasks generated and/or assigned via the retail task user interface, etc.

While one computer system 110 is shown, in some embodiments, the functionalities of the computer system 110 may be implemented on a plurality of processor devices communicating on a network such as a cloud-based computing engine. In some embodiments, the computer system 110 may be coupled to a plurality of user interface devices 140 and simultaneously support multiple instances of the user interface application on each user interface device 140 to provide sales forecast and/or task management.

Referring now to FIG. 2, a method for providing sales forecasts with clustering is shown. In some embodiments, the steps shown in FIG. 2 may be performed by a processor-based device such as a control circuit executing a set of computer-readable instructions stored on a computer-readable memory. In some embodiments, one or more steps of FIG. 2 may be performed by the computer system 110 described with reference to FIG. 1 herein or a similar device.

In step 210, the system aggregates sales data from retail stores. In some embodiments, sales data may be aggregated based on transactions carried out at one or more point of sale (POS) devices. POS devices may comprise clerked checkout terminals, self-service checkout terminals, and/or mobile checkout applications. In some embodiments, a POS device may comprise one or more of an optical scanner (e.g., barcode scanner), wireless sensor (e.g., RFID scanner), card reader, weight scale, touch screen, receipt printer, etc. In some embodiments, the aggregated sales data may be tagged with sales dates and stored in a sales history database.

In step 220, the system provides a retail task user interface to one or more user devices. In some embodiments, the retail task user interface is configured to provide information to workers at a retail store location relating to the operation of the store location. In some embodiments, the retail task user interface may comprise a task management function that provides a graphical user interface (GUI) for tasks to be created, assigned, accepted, and/or updated by users. In some embodiments, the retail task user interface may provide other information such as event sales forecast information as discussed herein.

In step 230, the system clusters store locations based on shared characteristics. In some embodiments, the system may retrieve a list of store locations associated with a retail entity. The list of stores may be physically located in different geographic locations. In some embodiments, shared characteristics comprise geographical location, past store sales, customer demographic, and/or store size. For example, stores within a metropolitan area with a similar customer demographic may be clustered together. In some embodiments, customer demographic information may be determined based on publicly available data (e.g., census data) and/or on member data from a membership program of the retail entity.

In step 240, the system determines a local sales forecast value for a future date for a store location. In some embodiments, the future date is associated with an event such as a holiday, a local event (e.g., sporting event, fair), and/or a store event (e.g., sales, promotion). In some embodiments, the system may further identify the event associated with the date, and the event characteristics/identifier is used by the forecast model. In some embodiments, an event may include a period of multiple days, and the forecast may cover multiple dates in the event period. In some embodiments, the local sales forecast is associated with a particular item, with a subcategory of items, or a category of items. In some embodiments, the local sales forecast value is determined via a computer forecast model based on the sales history of the store location. In some embodiments, the forecast model comprises a model for time series data based on an additive model where non-linear trends are fit with yearly, weekly, and daily seasonality, and holiday effects. In some embodiments, the forecast comprises a weighted average model with anomaly removal. In some embodiments, the model may use time decay and weigh newer data more heavily than older data. In some embodiments, the model may use historical data from a rolling window of 3, 4, 5 years or more. In some embodiments, any suitable forecast may be used, such as linear regression models, machine learning models, etc. For example, a machine learning model may be trained using sales data and event information data in the training data set and be configured to output a forecast value using events/dates as input. In some embodiments, the forecast comprises a baseline value and a percentage lift over the baseline value. The local sales forecast value is determined based on generating a first forecast value using the first forecast model, generating a second forecast value using a second forecast model, and combining the first forecast value and the second forecast value. For example, the system may generate a first forecast value using FBprophet and a second forecast value using a weighted average model. In some embodiments, the local sales forecast value determined in step 240 and the group sales forecast value determined in step 245 may comprise a baseline value and a sales lift value or percentage.

In step 245, the system determines the group sales forecast value. In some embodiments, the group sales forecast value is based on determining sales forecast values of other store locations of the store locations clustered in step 230. In some embodiments, the sales forecast values for each store may be determined similarly to the process described with reference to step 240. In some embodiments, the sales forecast for each store may be reused for the specific store as well as for determining the adjusted sales forecast for other stores in the cluster. In some embodiments, the group sales forecast value may be the average value of the sales forecast values of each of the other store locations in the cluster. In some embodiments, the sales forecast values may be weighted differently to determine the group sales forecast value based on, for example, data completeness and past accuracy.

In step 250, the system determines an adjusted sales forecast for the store location. In some embodiments, the adjusted sales forecast is determined based on the local sales forecast value determined in step 240 and the group sales forecast value determined in step 245. In some embodiments, the adjusted sales forecast is determined based on average sales forecast values associated with each store location in the cluster. In some embodiments, the adjusted sales forecast is determined based on applying a first weighting factor to the local sales forecast value and a second weighting factor to the group sales forecast value. In some embodiments, the local forecast value may be weighted more heavily than the group sales forecast value. In some embodiments, the system retrieves the first weighting factor and the second weighting factor from a plurality of weighting factors based on a holiday associated with the future date, a category associated with the local sales forecast value, a sub-category associated with the local sales forecast value, and/or an identifier associated with the store location. For example, a plurality of weighting factors may be stored in a database, with each weighting factor being associated with a store location, an item/category, and an event. In some embodiments, the adjusted sales forecast comprises a percentage sales lift compared to a baseline sales volume, and the forecasted sales volume is determined based on applying the adjusted lift percentage to the baseline volume. In some embodiments, local and adjusted forecast values may be determined for a plurality of items and a plurality of events and stored in a forecast database.

In step 260, the adjusted sales forecast is provided on the retail task user interface. In some embodiments, the user interface may provide a plurality of adjusted sales forecasts associated with different store locations, events, categories, subcategories, and items. In some embodiments, the user interface may display a plurality of events in chronological order. The sales forecast for the store, for one or more categories, subcategories, and items may be displayed when an event is selected. In some embodiments, the user interface may display sales forecasts for a plurality of categories, subcategories and/or items together, each forecast being determined based on steps 230, 240, 245, and 250. In some embodiments, the display of the forecast further includes a task generation user interface that allows users to generate retail tasks based on the forecast. The system may automatically associate the task with the displayed category, subcategory, or item for which the forecast is displayed. In some embodiments, the system may further automatically suggest and/or determine a retail task based on the adjusted sales forecast and cause the retail task to be instructed via the retail task user interface. For example, the system may compare the forecast value with inventory information of the store location and determine whether shelves need to be rezoned or stocked, reserved units need to be retrieved, and/or incoming inventory should be expedited for processing, etc.

In step 270, after the date of the forecast has passed, the system may compare the adjusted forecast with the actual sales of the date. The system may then update the weighting factors used in step 250. For example, if the local sales forecast value is closer to the actual sales, the weighting factor for the local sales forecast value may be increased. In some embodiments, the system may calculate weighting factors for the local and group sales forecasts such that the adjusted sales forecast matches the actual sales. In some embodiments, the system may further determine/update weighting factors for each store location within the group sales forecast value. In some embodiments, the system may further change the clustering of the store locations for subsequent forecasts. For example, the system may select stores that have similar actual sales for inclusion in the cluster. In some embodiments, data on actual sales may be recorded based on the sales data aggregation described in step 210. With the process shown, the system may execute a feedback loop that automatically updates the weighting of local and group sales forecast values to improve the prediction accuracy.

In some embodiments, one or more steps shown in FIG. 2 may be repeated for different store locations, different dates, different events, different categories, different subcategories, and/or different items to provide a granular sales forecast. In some embodiments, same or different clustering of the stores may be used for forecasting the sales associated with different events, categories, subcategories, and item forecasts for a specific store.

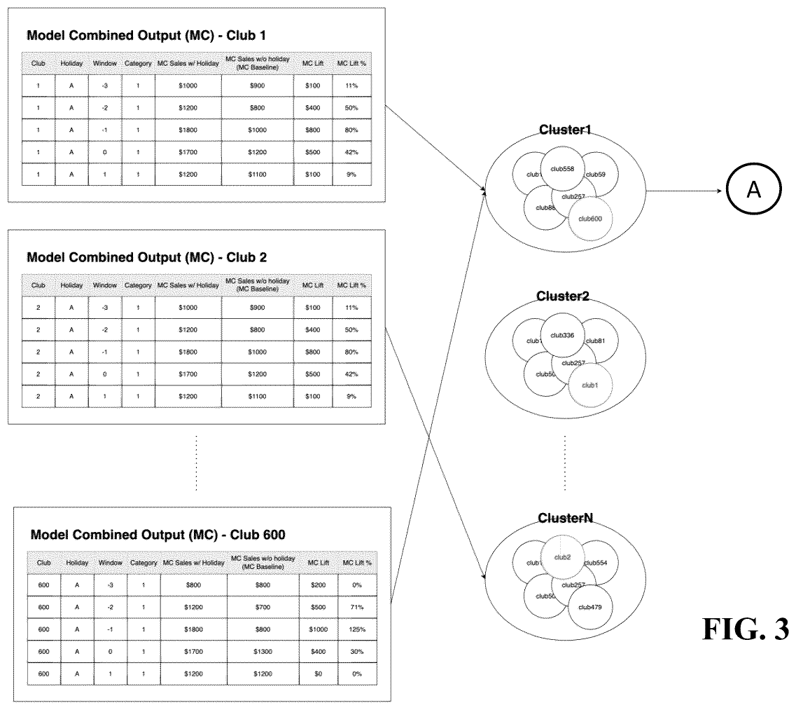

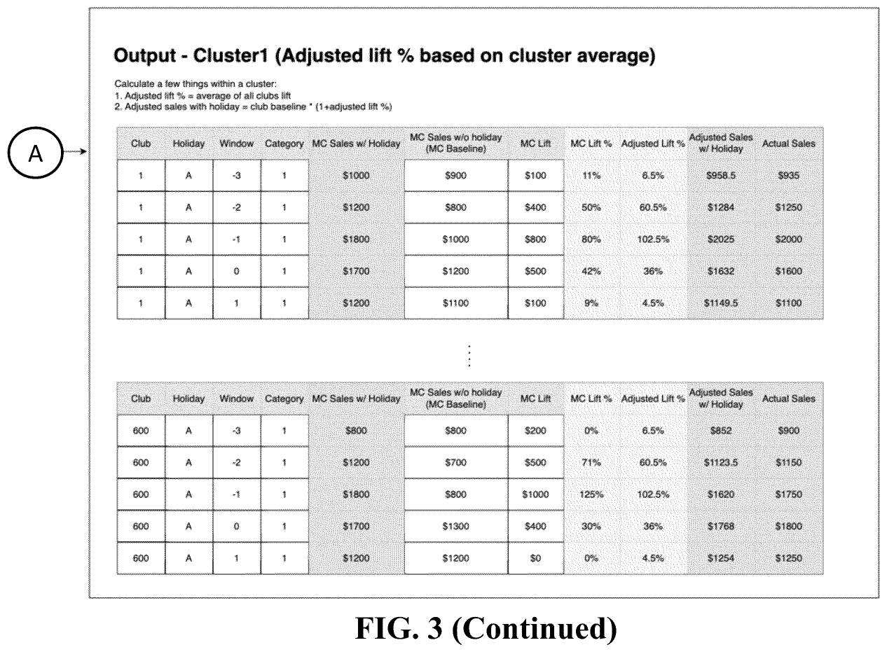

FIG. 3 illustrates an example of clustering of local and group sales data. As shown in FIG. 3, stores of a retail entity may be clustered into groups such as cluster 1, cluster 2 to cluster N. Each cluster can include any number of stores (referred to as clubs in FIG. 3). For each of clubs 1, 2, through 600, local sales forecast values are determined for 3 days prior, 2 days prior, 1 day prior, the day of, and a day after a specific holiday (“A”). Although 600 clubs are illustrated in the illustrative example of FIG. 3, those with skill in the art will recognize that various examples of this disclosure include more or less than 600 clubs. The forecast includes a baseline prediction and a lift prediction. In some embodiments, the forecast values are determined based on combining two or more prediction models. In some embodiments, the local forecast values may be determined based on the process described with reference to step 240 herein.

In FIG. 3, club 1 and club 600 are both grouped into cluster 1. An adjusted lift percentage and adjusted sales prediction are then calculated for clubs 1 and 600 based on local sales forecast values of other clubs in cluster 1. In FIG. 3, the adjusted lift percentages of club 1 and club 600 match after the adjustment. However, since their baseline sales differ, the adjusted sales predictions are different for the two clubs. In some embodiments, when weighting factors are applied, the adjusted lift percentage value may be different for each club in the cluster. In some embodiments, the adjusted lift percentages may be determined based on the process described with reference step 250 described herein. FIG. 3 further shows the actual sales which may be used to adjust the prediction models, clustering, and/or weighting factors for further predictions. The actual sales may also become sales history used by prediction models for subsequent predictions.

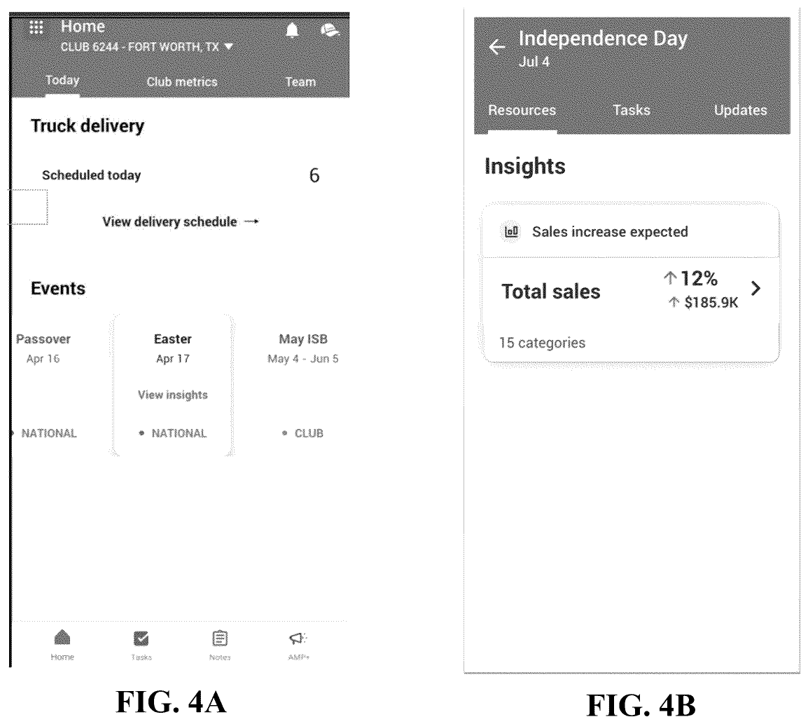

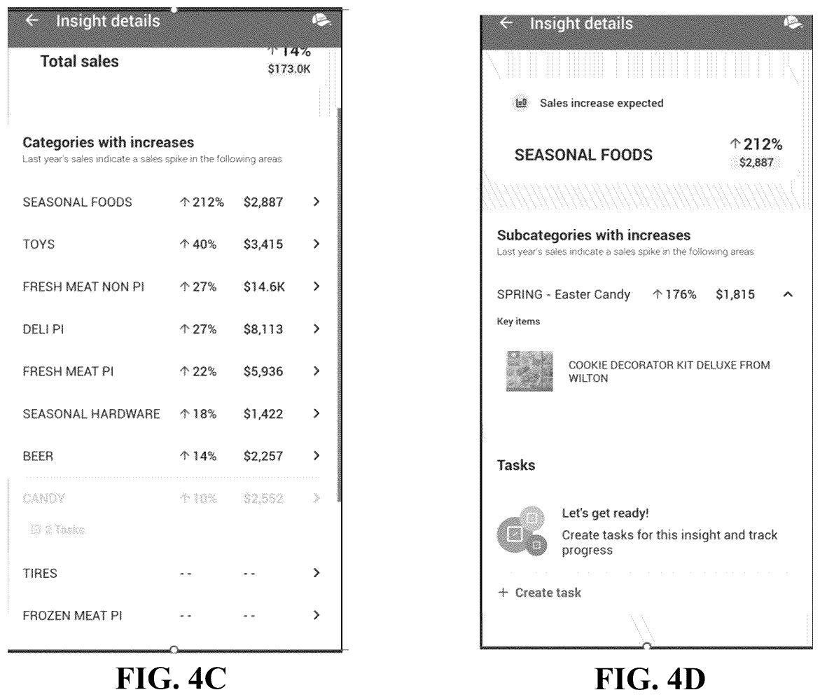

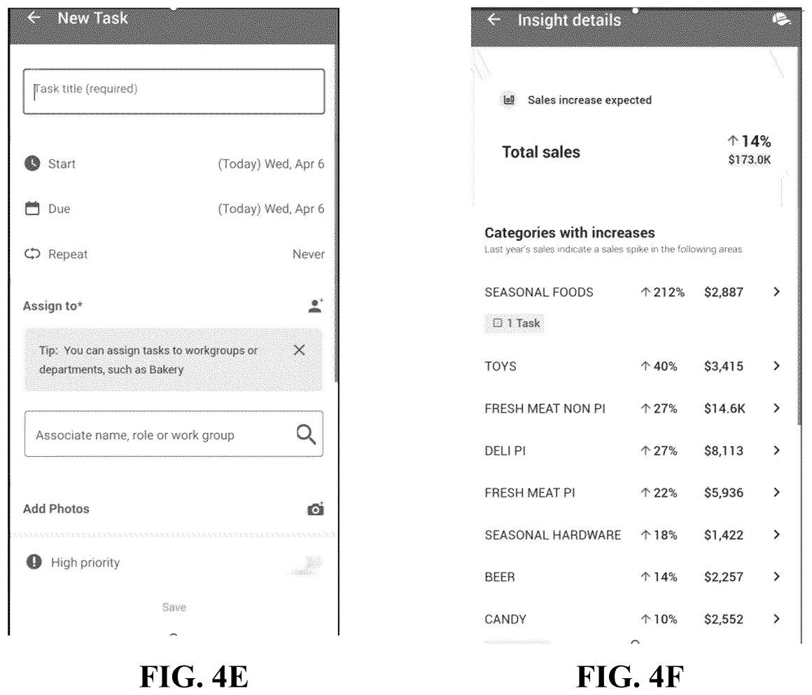

FIGS. 4A-F comprise illustrations of displays of a retail task user interface according to some embodiments. In FIG. 4A, an events display is shown. In the display, a number of selectable upcoming events are shown. The display of the event may include a name (e.g., “easter”), date(s), an event type identifier (e.g., national/club/local), and forecast insight data availability (“view insights”). After an event is selected, an insight display is shown in FIG. 4B may be shown that shows the overall sales forecast associated with the event. For example, in FIG. 4B, a sales increase of 12%, associated with $185.9 k, is forecasted. The user interface may further display forecasts in individual categories as shown in FIG. 4C. For example, forecasts associated with seasonal foods, toys, fresh meat, deli, etc. are displayed. In some embodiments, the user interface may rank the categories based on the amount of change and selectively display a subset of all categories based on the ranking. In FIG. 4C for example, only the top categories with expected sales increases are displayed. In some embodiments, each category may be user selectable to access further information/functions associated with each category as shown in FIG. 4D. In the user interface shown in FIG. 4D, “seasonal foods” is selected and the predicted sales increase of a subcategory (e.g., “spring—easter candy”) is shown along with a key item within the sub-category. In some embodiments, the user interface further integrates task assignment functionalities. When the task function is selected, as shown in FIG. 4E, a task creation interface is displayed. In the task creation interface, the user can input various information associated with the task such as a task title, a start date, a due date, repeat settings, team members, photo, and priority. In some embodiments, one or more of the fields may be auto populated based on the prediction and/or the subcategory associated with the task, such as the subcategory shown in FIG. 4D. Once a task is created under a category, the display of categories may be updated to show an indication of the task as shown in FIG. 4F. With the retail task user interface, a store manager may easily determine and view tasks that should be completed in anticipation of sales increase associated with an event.

In some aspects, the techniques described herein relate to a system for retail forecast and task management, the system includes: a sales history database storing sales histories associated with a plurality of store locations; a network adapter; and a control circuit coupled to the sales history database and the network adapter, the control circuit being configured to: provide, via the network adapter, a retail task user interface on a user device at a store location; cluster a plurality of store locations based on shared characteristics, the plurality of store locations includes the store location; determine a local sales forecast value on a future date for the store location based on a sales history of the store location using at least a first forecast model; determine a group sales forecast value on the future date based on sales histories of other store locations of the plurality of store locations using at least the first forecast model; determine an adjusted sales forecast for the store location based on the local sales forecast value and the group sales forecast value; and provide, on the retail task user interface, the adjusted sales forecast.

In some aspects, the techniques described herein relate to a method for retail forecast and task management, the method includes: providing, from a control circuit via a network adapter, a retail task user interface on a user device at a store location; clustering, with the control circuit, a plurality of store locations based on shared characteristics, the plurality of store locations includes the store location; determining, with the control circuit, a local sales forecast value on a future date for the store location based on a sales history of the store location using at least a first forecast model, wherein the sales history is retrieved from a sales history database storing sales histories associated with a plurality o store locations; determining, with the control circuit, a group sales forecast value on the future date based on sales histories of other store locations of the plurality of store locations using at least the first forecast model; determining, with the control circuit, an adjusted sales forecast for the store location based on the local sales forecast value and the group sales forecast value; and providing, on the retail task user interface, the adjusted sales forecast.

Those skilled in the art will recognize that a wide variety of other modifications, alterations, and combinations can also be made with respect to the above-described embodiments without departing from the scope of the present disclosure and that such modifications, alterations, and combinations are to be viewed as being within the ambit of the inventive concept.

What is claimed is:

1. A system for retail forecasting and task management, the system comprising:
a sales history database storing sales histories associated with a plurality of store locations;
a network adapter; and
a control circuit coupled to the sales history database and the network adapter and configured to:
provide, via the network adapter, a retail task user interface on a user device at a store location;
cluster a plurality of store locations based on shared characteristics, the plurality of store locations including the store location;
determine a local sales forecast value on a future date for the store location based on a sales history of the store location using at least a first forecast model;
determine a group sales forecast value on the future date based on sales histories of other store locations of the plurality of store locations using at least the first forecast model;
determine an adjusted sales forecast for the store location based on the local sales forecast value and the group sales forecast value; and
provide, on the retail task user interface, the adjusted sales forecast.

2. The system of claim 1, wherein the shared characteristics comprise geographical location, past store sales, customer demographic, and/or store size.

3. The system of claim 1, wherein the adjusted sales forecast is determined based on applying a first weighting factor to the local sales forecast value and a second weighting factor to the group sales forecast value.

4. The system of claim 3, wherein the control circuit is configured to retrieve the first weighting factor and the second weighting factor from a plurality of weighting factors based on:
a holiday associated with the future date, a category associated with the local sales forecast value, a sub-category associated with the local sales forecast value, and/or an identifier associated with the store location.

5. The system of claim 3, wherein the control circuit is further configured to:
determine the first weighting factor and the second weighting factor based on comparing a prior local sales forecast and a prior group sales forecast with actual sales of a prior date.

6. The system of claim 1, wherein the control circuit is further configured to:
determine a retail task based on the adjusted sales forecast; and
cause the retail task to be instructed via the retail task user interface.

7. The system of claim 1, wherein the adjusted sales forecast comprises a percentage sales lift compared to a baseline sales volume.

8. The system of claim 1, wherein the adjusted sales forecast is associated with a particular item with a subcategory of items, or a category of items.

9. The system of claim 1, wherein the first forecast model comprises a forecast model for time series data based on an additive model where non-linear trends are fit with yearly, weekly, and daily seasonality, and holiday effects.

10. The system of claim 1, wherein the local sales forecast value is determined based on generating a first forecast value using the first forecast model, generating a second forecast value using a second forecast model, and combining the first forecast value and the second forecast value.

11. A method for retail forecasting and task management, the method comprises:
providing, from a control circuit via a network adapter, a retail task user interface on a user device at a store location;
clustering, with the control circuit, a plurality of store locations based on shared characteristics, the plurality of store locations including the store location;
determining, with the control circuit, a local sales forecast value on a future date for the store location based on a sales history of the store location using at least a first forecast model, wherein the sales history is retrieved from a sales history database storing sales histories associated with a plurality of store locations;
determining, with the control circuit, a group sales forecast value on the future date based on sales histories of other store locations of the plurality of store locations using at least the first forecast model;
determining, with the control circuit, an adjusted sales forecast for the store location based on the local sales forecast value and the group sales forecast value; and
providing, on the retail task user interface, the adjusted sales forecast.

12. The method of claim 11, wherein the shared characteristics comprise geographical location, past store sales, customer demographic, and/or store size.

13. The method of claim 11, wherein the adjusted sales forecast is determined based on applying a first weighting factor to the local sales forecast value and a second weighting factor to the group sales forecast value.

14. The method of claim 13, wherein the first weighting factor and the second weighting factor are retrieved from a plurality of weighting factors based on:
a holiday associated with the future date, a category associated with the local sales forecast value, a sub-category associated with the local sales forecast value, and/or an identifier associated with the store location.

15. The method of claim 13, further comprising:
determining the first weighting factor and the second weighting factor based on comparing a prior local sales forecast and a prior group sales forecast with actual sales of a prior date.

16. The method of claim 11, further comprising:
determining a retail task based on the adjusted sales forecast; and
causing the retail task to be instructed via the retail task user interface.

17. The method of claim 11, wherein the adjusted sales forecast comprises a percentage sales lift compared to a baseline sales volume.

18. The method of claim 11, wherein the adjusted sales forecast is associated with a particular item, with a subcategory of items, or a category of items.

19. The method of claim 11, wherein the first forecast model comprises a forecast model for time series data based on an additive model where non-linear trends are fit with yearly, weekly, and daily seasonality, and holiday effects.

20. The method of claim 11, wherein the local sales forecast value is determined based on generating a first forecast value using the first forecast model, generating a second forecast value using a second forecast model, and combining the first forecast value and the second forecast value.
